(19) United States
(12) Patent Application Publication
(10) Pub. No.: US 2023/0046907 A1
(43) Pub. Date: Feb. 16, 2023

(54) METHODS OF DETERMINING REDEMPTION OF CONTENT PROVIDED THROUGH SOCIAL MEDIA MARKETING USING A POS SYSTEM AND RELATED SYSTEMS

(71) Applicant: Toshiba Global Commerce Solutions Holdings Corporation, Tokyo (JP)

(72) Inventors: Susan W. Brosnan, Raleigh, NC (US); Tayon Dancy, Apex, NC (US); Manda Miller, Raleigh, NC (US); John Pistone, Cary, NC (US)

(21) Appl. No.: 17/399,378

(22) Filed: Aug. 11, 2021

(51) Int. Cl. G06Q 20/38; G06Q 20/32; H04L 9/32; G06Q 20/20; G06Q 30/02

(52) U.S. Cl. CPC G06Q 20/3825; G06Q 20/3274; H04L 9/3213; G06Q 20/202; G06Q 30/0238; H04L 2209/56

(57) ABSTRACT

A method and system are provided for validating a promotional token redeemed at a Point-of-Sale (PoS) terminal, can include receiving, at the Point of Sale (PoS) terminal located at a physical retail location, a promotional token ID from a mobile device associated with a customer. The promotional token ID can be configured to uniquely identify a promotional token to promote a consumer packaged good (CPG) distributed on a social media platform. A CPG is entered at the PoS terminal to determine a CPG ID configured to uniquely identify the CPG. Next, a validation request is generated. The validation request comprises the promotional token ID and the CPG ID. The validation request is then transferred to a server having access to a private blockchain ledger. Upon completion, the PoS terminal will receive, from the server, the redemption status for the promotional token ID based on information stored in the private blockchain ledger responsive to the validation request.

### FIELD

The present inventive concept generally relates to a process for the management and redemption of electronic coupons.

### BACKGROUND

Nearly all consumers can be reached with digital marketing content and media through digital networks such as social media sites (Facebook, Instagram) and entertainment hubs (YouTube, Netflix). These networks have sophisticated consumer preference algorithms and process petabytes of consumer data. Consumer Packaged Goods (CPG) companies and retail brands spend billions of dollars delivering marketing content directly to consumers via these digital networks. It is relatively easy to identify and quantify digital/e-commerce purchases related to this content if the consumer uses the links found within the content on the social media platform.

### SUMMARY

Some embodiments of the present inventive concept provide a method and system for validating a promotional token redeemed at a Point-of-Sale (PoS) terminal. The method can include receiving, at the Point-of-Sale (POS) terminal located at a physical retail location, a promotional token ID from a mobile device associated with a customer. The promotional token ID can be configured to uniquely identify a promotional token to promote a consumer packaged good (CPG) distributed on a social media platform. A CPG is entered at the POS terminal to determine a CPG ID configured to uniquely identify the CPG. Next, a validation request is generated. The validation request comprises the promotional token ID and the CPG ID. The validation request is then transferred to a server having access to a private blockchain ledger. Upon completion, the POS terminal will receive, from the server, the redemption status for the promotional token ID based on information stored in the private blockchain ledger responsive to the validation request.

### BRIEF DESCRIPTION OF THE DRAWINGS

FIG. 1 is a flowchart of the method for creating promotional token in accordance with some embodiments of the present inventive concept.

FIG. 2 is a flowchart of the method for sending, receiving a validation request and completing a sales transaction based on a redemption status for the promotional token in accordance with some embodiments of the present inventive concept.

FIG. 3 is a flowchart of the method for completing a sales transaction at a POS based on the redemption status in accordance with some embodiments of the present inventive concept.

FIG. 4 is a block diagram of a data processing system for use with the Point-of-Sale terminal (POS) in accordance with some embodiments of the present inventive concept.

### DETAILED DESCRIPTION OF EMBODIMENTS

The inventive concept now will be described more fully hereinafter with reference to the accompanying drawings, in which illustrative embodiments of the inventive concept are shown. This inventive concept may, however, be embodied in many different forms and should not be construed as limited to the embodiments set forth herein; rather, these embodiments are provided so that this disclosure will be thorough and complete, and will fully convey the scope of the inventive concept to those skilled in the art. Like numbers refer to like elements throughout. As used herein, the term “and/or” includes any and all combinations of one or more of the associated listed items. Similarly, as used herein, the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

As appreciated by the present inventors, a blind spot remains for understanding if digitally delivered content influences in-store purchases. Consumers still opt to buy in-store, particularly for segments such as grocery.

As further appreciated by the present inventors, fraud is a significant issue within social media/networks and digital content. Many consumers have fallen victim to messages and links of malicious intent meant to gain access to consumer information or friend list. Consumer packaged goods (CPG) and retailers are victims of redemption of fraudulent promotions and malicious content disguised as their content, negatively affecting consumer trust and loyalty. CPGs and retail brands are spending a lot of money marketing on these networks but are unable to account for 63% of the spending. This equates to about $12B per year of black box marketing funds, where they do not know if digital marking is influencing purchases, particularly in-store.

Accordingly, in some embodiments, according to the invention, a private blockchain platform can be utilized by a point-of-sale system network to authenticate promotional media on social media/content networks and follow the promotional media on its journey to redemption in-store.

As used herein, the term “private blockchain” shall generally mean a distributed database that maintains a continuously growing ledger or list of records, called blocks, secured from tampering and revision. The private blockchain is only accessible by parties who are members of the private blockchain and not the general public.

A private blockchain ledger, accessible by the server, may contain one or more databases. The data may comprise any information pertinent to the generation and processing of promotional tokens, including information on or describing one or more members of the private blockchain, information on or describing one or more promotional tokens, or any other information which may be used to enable a customer to receive a product, such as goods and services, at a free or reduced price.

There are several entities that can join the private blockchain after validation. Each entity is associated with a unique member identifier to become validated. These entities include, but are not limited to, one or more consumer packaged goods (CPG), retailers, social media network sites, consumer, point-of-sale systems (POS), blockchain distribution channels and central control. The social media network site can deliver the promotional media to consumers via the platform. The point-of-sale system can be associated with a validated retailer and equipped to access the blockchain platform nodes or function as a node to validate the ledger. The central control may include a cloud, computer network nodes for the blockchain platform.

Consumers can opt-in to join the (blockchain) platform and link their loyalty cards and social networking profile credentials to their accounts. Consumers' accounts are validated based on the information provided and data supplied by social media networks and loyalty databases. Once opted-in, they can designate to receive only (blockchain) platform account content for each of their social media networks via settings. Otherwise, all types of content can be delivered to them, but content originating from the platform will be clearly marked and can only originate via the validated social media network entity. The string of the private blockchain ledger would follow a specific pattern for a particular scenario of a promotion delivered on social media.

As used herein, “POS” refers to a Point-of-Sale is defined as the device used to complete a sales transaction. It is a combination of POS software and hardware. The device can be anything from a computer, tablet, or mobile device used to conduct sales. POS software is the software application that powers the point-of-sale terminal. It is the primary tool used to process payments, store data, manage business functions.

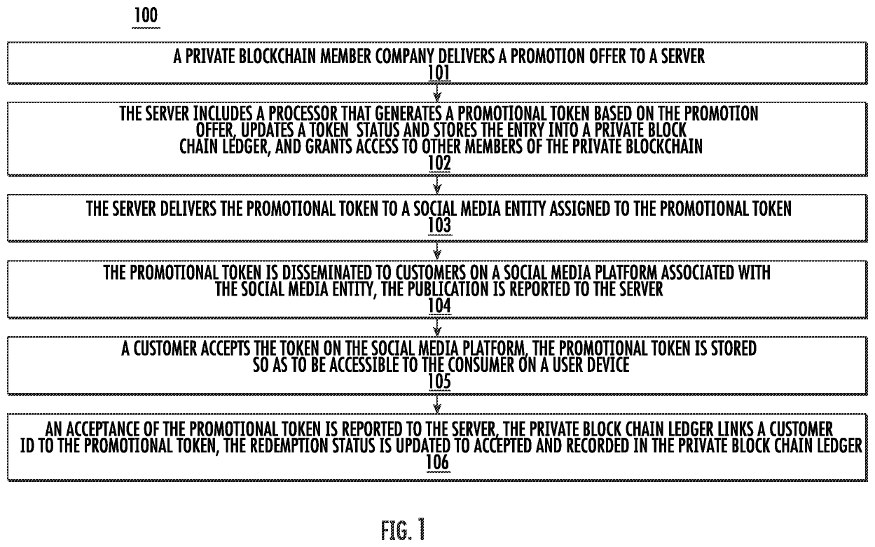

Referring first to FIG. 1, a flowchart illustrating processing steps for creating a promotional token in accordance with some embodiments of the present inventive concept will be discussed. Promotional offers are digital coupons, namely, discounts, offers and promotions offered to current or prospective customers. Similar to their tangible counterparts (i.e., paper coupons), digital coupons aim to entice a consumer to make a purchase. Digital coupon types include downloadable and non-downloadable coupons, coupon barcodes, coupon codes, member rewards, and bundle deals. If verified, the promotional offers are automatically applied during checkout at a retail location.

The creation of a promotional offer begins at step 101. At this step, a retailer member of a private blockchain creates a promotional offer for a particular service or consumer packaged good (CPG). The retail member assigns a social media entity to the promotional offer. Current promotional offers may be updated using the same process. The new or updated promotional offer is then delivered to a server where the promotion offer is stored in a private blockchain ledger. At step 102, the server processor generates a promotional token based on the promotion offer, updates a token status, and stores the entry into the private blockchain ledger. Once stored, the server grants access to other members of the private blockchain.

At step 103 the server delivers the promotional token to one or more social media entities assigned to the promotional token according to the information stored in the private blockchain ledger.

At step 104 the promotional token is disseminated to customers through one or more social media platforms associated with the social media entity. Once published on a social media platform to consumers, the social media entity reports the publication to the server. The promotional token status is updated to published and stored in the private blockchain ledger.

Each promotion token is disseminated to multiple consumers via the social network entity, but each consumer must have a unique identifier and be a member of the blockchain platform. Each promotional content delivery to a consumer is added and stored as a transaction to the private blockchain ledger. Authentication of marketing content originating from the social media platform presented to the consumer may be implemented in various ways. Including, for example, restricting the presentation of the promotion to a specific social network entity. Another authentication method includes implementing security protocols to detect and remove any advertisements that did not originate from the platform but are posing as such. This method will allow only the social media entity permission to add a promotional token to the private blockchain ledger. Authentication may also be performed by enabling consumers on the social media platform to designate through the social media site settings to receive only promotions originating from the blockchain platform.

The published promotional token may be viewed and accepted through the social media platform at step 105. Acceptance may also include storing and downloading the promotional token, for example, a QR code on a mobile device. Once accepted by the customer (step 106), the social media entity reports a notification of the acceptance to the server. The promotional token is then linked to the consumer at the server, for example, through customer loyalty card information and other identifying ledger information. The private blockchain ledger then links a customer ID to the promotional token. Finally, a redemption status is updated to accepted and recorded in the private blockchain ledger.

The promotional token is redeemable during checkout at a point-of-sale terminal and physical retail location associated with the promotional token.

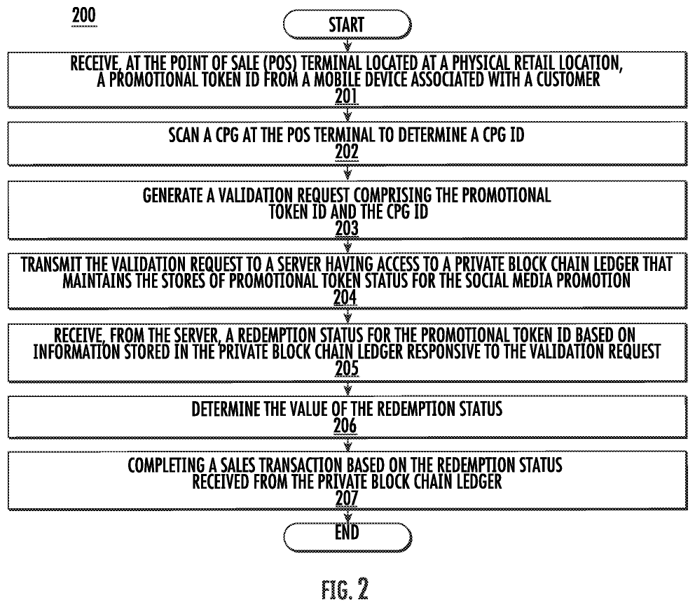

FIG. 2 is a flowchart illustrating processing steps for sending and receiving a validation request and completing a sales transaction based on a redemption status for the promotional token in accordance with some embodiments of the present inventive concept.

Once accepted by a customer, as discussed above in step 105, the promotional token may be downloadable or displayable on a mobile device associated with the customer and redeemed at a physical retail location in the checkout process. During checkout (step 201), the POS terminal receives, from a mobile device associated with the customer, the promotional token and determines a promotional token ID associated with the promotional token. CPG items may be scanned or entered (step 202) in the POS terminal. POS input methods for receiving and entering promotional token and CPG data may include any conventional POS terminal input method for entering data into the POS terminal. The CPG may be scanned with a bar code reader, but it could equally be hand-keyed, recognized from a camera or pulled from RFID. Once scanned or entered, the POS terminal determines a CPG ID configured to uniquely identify the CPG.

Upon receiving the Token ID and CPG ID, the POS terminal generates a validation request comprising the promotional token ID and the CPG ID (step 203). The validation request is then transmitted to the server 408 having access to the private blockchain ledger 407 (step 204).

Although FIG. 2 shows a specific order of execution, namely step 101, the POS terminal receives, from a mobile device associated with the customer, the promotional token and determines a promotional token ID associated with the promotional token, followed with step 202, the CPG items may be scanned or entered in the POS terminal. It is understood that the order of execution may differ from that which is depicted. For example, step 102 may occur before step 101.

The validity of the promotional token may be determined at the server 407 according to a current redemption status data stored in the private blockchain ledger 408 associated with the token ID received in the validation request. The redemption status may be marked as either approved or denied.

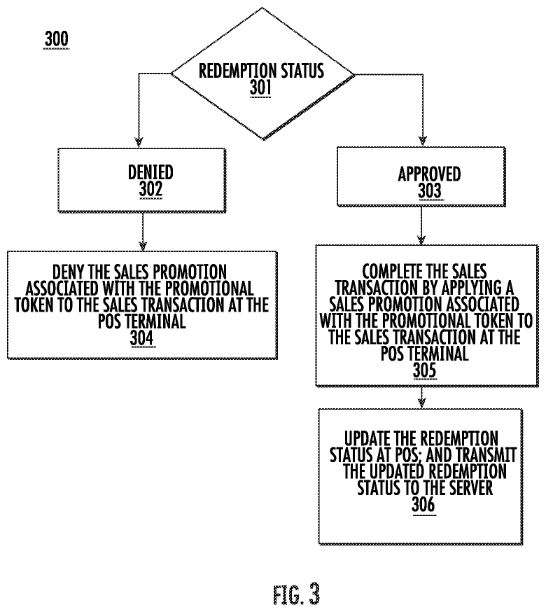

FIG. 5 illustrates a process wherein once the validity of the promotional token is obtained, the POS terminal will receive, from the server, a redemption status for the promotional token ID based on information stored in the private blockchain ledger responsive to the validation request. According to FIG. 3, after receiving the redemption status (step 301), the POS terminal will determine if the promotional token is approved 303 or denied 302. An approved 303 redemption status indicates that the promotional token is available for use at a POS terminal. The sales transaction is completed at step 305 by applying the sales promotion associated with the promotional token to the sales transaction at the POS terminal. When the transaction is completed the POS terminal updates the status of the promotional token at the POS terminal and transmits a request to the server to update the redemption status of the promotional token (step 306).

A denied redemption status indicates that the promotional token is not available for use at a POS terminal. As a result, the sales transaction is completed at step 303 without applying the sales promotion associated with the promotional token to the sales transaction at the POS terminal.

With this approach, a retailer can see when a promotional token is “clipped”, where each promotional token lies within the redemption process and has visibility into redemption via the in-store channel. Other scenario examples may include a retailer-sponsored promotional token and/or consumers transferring promotional tokens to other users within the platform. Central Control could be a member company that can access the (blockchain) platform. The member company could validate the POS Systems, CPGs, and retailer member entities. Consumer validation can be handled by social media network sites and retailer loyalty programs.

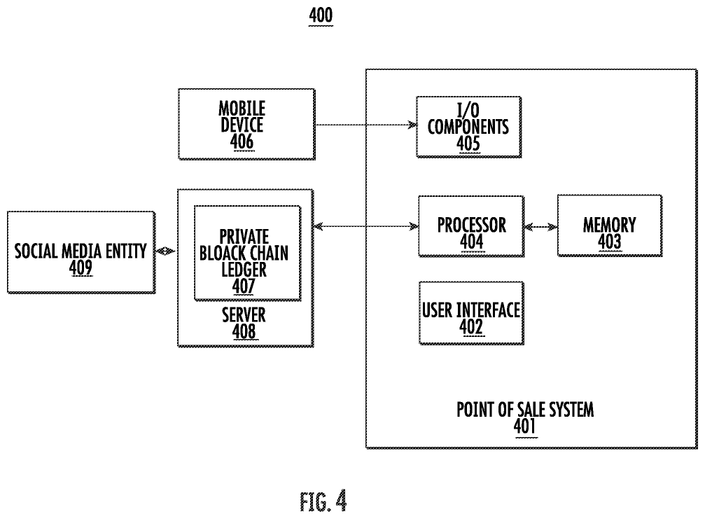

Referring now to FIG. 4, an example of a point-of-sale terminal 401 suitable for use with any of the examples described above. Although the example point-of-sale terminal 401 is shown as in communication with the server 408 in accordance with embodiments of the present inventive concept, the point-of-sale terminal 401 may also be part of a network of point-of-sale modules in communication with the server 408 or any other component of the terminal without departing from the scope of the present inventive concept. In some examples, the point-of-sale terminal 401 can be any suitable computing device for performing operations according to the embodiments discussed herein described herein.

As illustrated, the point-of-sale terminal 401 includes a processor 404 communicatively coupled to I/O components 406, a user interface 402, and a memory 403. The processor 404 can include one or more commercially available processors, embedded processors, secure processors, microprocessors, dual microprocessors, multi-core processors, other multi-processor architectures, another suitable processing device, or any combination of these. The memory 404, which can be any suitable tangible (and non-transitory) computer-readable medium such as random access memory (RAM), read-only memory (ROM), erasable and electronically programmable read-only memory (EEPROMs), or the like, embodies program components that configure the operation of the point-of-sale terminal 401.

The mobile device 406 can include, for example, an end-user device such as a personal computer (PC), a mobile device such as a smartphone, laptop, VoIP phone, IoT device, or another telephonic device capable of displaying the promotional token.

I/O components 405 may be used to facilitate wired or wireless connections to devices such as one or more displays, scanners, controllers, keyboards, mice, joysticks, cameras, buttons, speakers, microphones and/or other hardware used to input or output data. Memory 103 represents non-volatile storages such as magnetic, optical, or other storage media included in the data processing system and/or coupled to processor 404.

The user interface 402 may include, for example, a keyboard, keypad, touchpad, voice activation circuit, display, or the like, and the processor 404 may execute program code or instructions stored in memory 403.

It should be appreciated that the point-of-sale terminal 401 may also include additional processors, additional storage, and a computer-readable medium (not shown). The processor(s) 404 may execute additional computer-executable program instructions stored in memory 403. Such processors may include a microprocessor, digital signal processor, application-specific integrated circuit, field programmable gate arrays, programmable interrupt controllers, programmable logic devices, programmable read-only memories, electronically programmable read-only memories, or other similar devices.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Reference will now be made in detail in various and alternative example embodiments and to the accompanying figures. Each example embodiment is provided by way of explanation, and not as a limitation. It will be apparent to those skilled in the art that modifications and variations can be made without departing from the scope or spirit of the disclosure and claims. For instance, features illustrated or described as part of one embodiment may be used in connection with another embodiment to yield a still further embodiment. Thus, it is intended that the present disclosure includes modifications and variations that come within the scope of the appended claims and their equivalents.

The aforementioned flow logic and/or methods show the functionality and operation of various services and applications described herein. If embodied in software, each block may represent a module, segment, or portion of code that includes program instructions to implement the specified logical function(s). The program instructions may be embodied in the form of source code that includes human-readable statements written in a programming language or machine code that includes numerical instructions recognizable by a suitable execution system such as a processor in a computer system or other system. The machine code may be converted from the source code, etc. Other suitable types of code include compiled code, interpreted code, executable code, static code, dynamic code, object-oriented code, visual code, and the like. The examples are not limited in this context.

If embodied in hardware, each block may represent a circuit or a number of interconnected circuits to implement the specified logical function(s). A circuit can include any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Qualcomm® Snapdragon®; Intel® Celeron®, Core (2) Duo®, Core i3, Core i5, Core i7, Itanium®, Pentium®, Xeon®, Atom® and XScale® processors; and similar processors. Other types of multi-core processors and other multi-processor architectures may also be employed as part of the circuitry. According to some examples, circuitry may also include an application specific integrated circuit (ASIC) or a field programmable gate array (FPGA), and modules may be implemented as hardware elements of the ASIC or the FPGA. Further, embodiments may be provided in the form of a chip, chipset or package.

Although the aforementioned flow logic and/or methods each show a specific order of execution, it is understood that the order of execution may differ from that which is depicted. Also, operations shown in succession in the flowcharts may be able to be executed concurrently or with partial concurrence. Further, in some embodiments, one or more of the operations may be skipped or omitted. In addition, any number of counters, state variables, warning semaphores, or messages might be added to the logical flows or methods described herein, for purposes of enhanced utility, accounting, performance measurement, or providing troubleshooting aids, etc. It is understood that all such variations are within the scope of the present disclosure. Moreover, not all operations illustrated in a flow logic or method may be required for a novel implementation.

Where any operation or component discussed herein is implemented in the form of software, any one of a number of programming languages may be employed such as, for example, C, C++, C#, Objective C, Java, Javascript, Perl, PHP, Visual Basic, Python, Ruby, Delphi, Flash, or other programming languages. Software components are stored in a memory and are executable by a processor. In this respect, the term “executable” means a program file that is in a form that can ultimately be run by a processor. Examples of executable programs may be, for example, a compiled program that can be translated into machine code in a format that can be loaded into a random access portion of a memory and run by a processor, source code that may be expressed in proper format such as object code that is capable of being loaded into a random access portion of a memory and executed by a processor, or source code that may be interpreted by another executable program to generate instructions in a random access portion of a memory to be executed by a processor, etc. An executable program may be stored in any portion or component of a memory. In the context of the present disclosure, a “computer-readable medium” can be any medium (e.g., memory) that can contain, store, or maintain the logic or application described herein for use by or in connection with the instruction execution system.

A memory is defined herein as an article of manufacture and including volatile and/or non-volatile memory, removable and/or non-removable memory, erasable and/or non-erasable memory, writeable and/or re-writeable memory, and so forth. Volatile components are those that do not retain data values upon loss of power. Non-volatile components are those that retain data upon a loss of power. Thus, a memory may include, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may include, for example, static random access memory (SRAM), dynamic random access memory (DRAM), or magnetic random access memory (MRAM) and other such devices. The ROM may include, for example, a programmable read-only memory (PROM), an erasable programmable read-only memory (EPROM), an electrically erasable programmable read-only memory (EEPROM), or other like memory device.

The devices described herein may include multiple processors and multiple memories that operate in parallel processing circuits, respectively. In such a case, a local interface, such as a communication bus, may facilitate communication between any two of the multiple processors, between any processor and any of the memories, or between any two of the memories, etc. A local interface may include additional systems designed to coordinate this communication, including, for example, performing load balancing. A processor may be of electrical or of some other available construction.

It should be emphasized that the above-described embodiments of the present disclosure are merely possible examples of implementations set forth for a clear understanding of the principles of the disclosure. It is, of course, not possible to describe every conceivable combination of components and/or methodologies, but one of ordinary skill in the art may recognize that many further combinations and permutations are possible. That is, many variations and modifications may be made to the above-described embodiment(s) without departing substantially from the spirit and principles of the disclosure. All such modifications and variations are intended to be included herein within the scope of this disclosure and protected by the following claims.

1. A method of validating a promotional token redeemed at a Point-of-Sale (POS) terminal comprising:
receiving, at the Point-of-Sale (POS) terminal located at a physical retail location, a promotional token ID from a mobile device associated with a customer, wherein the promotional token ID is configured to uniquely identify a promotional token, for a promotion of a consumer packaged good (CPG) distributed on a social media platform;
entering a CPG at the POS terminal to determine a CPG ID that is configured to uniquely identify the CPG;
generating a validation request comprising the promotional token ID and the CPG ID; transmitting the validation request to a server having access to a private blockchain ledger; and
receiving, from the server, a redemption status for the promotional token ID based on information stored in the private blockchain ledger responsive to the validation request.

2. The method of claim 1, further comprising:
determining the value of the redemption status; and completing a sales transaction based on the redemption status received from the private blockchain ledger.

3. The method of claim 2, wherein completing a sales transaction comprises:
if the received redemption status is determined by the POS terminal to be marked as approved, completing the sales transaction by applying a sales promotion associated with the promotional token to the sales transaction at the POS terminal.

4. The method of claim 2, wherein completing a sales transaction comprises:
if the received redemption status is determined by the POS terminal to be marked as denied, completing the sales transaction without applying a sales promotion associated with the promotional token to the sales transaction at the POS terminal.

5. The method of claim 1, wherein the promotional token ID is received from a mobile device display, wherein the mobile device display includes a QR code that is accessible through the social media platform.

6. The method of claim 1 further comprising: transmitting a point-of-sale member ID configured to identify a retailer that operates the POS terminal as a member of the private blockchain ledger, after receiving the redemption status.

7. The method of claim 1, wherein the promotional token is accepted by the customer using a social media account associated with the customer.

8. The method of claim 2, further comprising upon the completion of the sales transaction, forwarding an indication after completion to the server identifying that the promotional token has been redeemed by:
updating the redemption status; and transmitting the updated redemption status to the server.

9. The method of claim 1, wherein a retailer that operates the POS terminal, a CPG provider, the social media platform, and an account associated with customer are members of the private blockchain ledger.

10. A system for validating a promotional token redeemed at a Point-of-Sale (POS) terminal comprising:
a Point-of-Sale (POS) terminal configured to receive at a physical retail location, a promotional token ID from a mobile device associated with a customer, wherein the promotional token ID is configured to uniquely identify a promotional token, for a promotion of a consumer packaged good (CPG) distributed on a social media platform;
enter a consumer packaged good (CPG) at the POS terminal to determine a CPG ID that is configured to uniquely identify the CPG;
generate a validation request comprising the promotional token ID and the CPG ID; transmit the validation request to a server having access to a private blockchain ledger; and receive, from the server, a redemption status for the promotional token ID based on information stored in the private blockchain ledger responsive to the validation request.

11. The system of claim 10, wherein the POS terminal is further configured to:
determine the value of the redemption status; and complete the sales transaction based on the redemption status received from the private blockchain ledger.

12. The system of claim 11, wherein if the value of the redemption status has been marked as approved, complete the sales transaction by applying a sales promotion associated with the promotional token to the sales transaction at the POS terminal.

13. The system of claim 11, wherein if the value of the redemption status has been marked as denied, complete the sales transaction without applying a sales promotion associated with the promotional token to the sales transaction at the POS terminal.

14. The system of claim 10, wherein the POS terminal is further configured to receive the promotional token ID from a mobile device display, wherein the mobile device display includes a QR code that is accessible through the social media platform.

15. The system of claim 10, wherein the POS terminal is further configured to transmit a point-of-sale member ID configured to identify a retailer that operates the POS terminal as a member of the private blockchain ledger, after the redemption status is received.

16. The system of claim 10, wherein the promotional token is accepted by the customer using a social media account associated with the customer.

17. The system of claim 11, wherein the POS terminal is further configured to forward an indication of completion to the server to identify that the promotional token has been redeemed, whereby and update is made to the redemption status upon the completion of the sales transaction at the POS terminal; and the updated redemption status is transmitted to the server.

18. The system of claim 11, wherein a retailer that operates the POS terminal, a CPG provider, the social media platform, and an account associated with customer are members of the private blockchain ledger.

19. At least one machine-readable non-transitory medium comprising a set of instructions executable on a computing device operating as a Point-of-Sale (POS) terminal to cause the computing device to validate a promotional token by:
receiving, at the Point-of-Sale (POS) terminal located at a physical retail location, a promotional token ID from a mobile device associated with a customer, wherein the promotional token ID is configured to uniquely identify a promotional token;
entering a consumer packaged good (CPG) at the POS terminal to determine a CPG ID that is configured to uniquely identify the CPG, for a promotional of a CPG distributed on a social media platform;
generating a validation request comprising the promotional token ID and the CPG ID;
transmitting the validation request to a server having access to a private blockchain ledger; and
receiving, from the server, a redemption status for the promotional token ID based on information stored in the private blockchain ledger responsive to the validation request.

20. (canceled)

21.-23. (canceled)
